(19) United States
(12) Patent Application Publication
(10) Pub. No.: US 2024/0270953 A1
(43) Pub. Date: Aug. 15, 2024

(54) ELECTRO-MECHANICAL POLYMERS AND DEVICES CONTAINING THE SAME

(71) Applicant: The Penn State Research Foundation, University Park, PA (US)

(72) Inventors: Qiming Zhang, University Park, PA (US); Xin Chen, University Park, PA (US)

(21) Appl. No.: 18/565,790

(22) PCT Filed: Jun. 3, 2022
(86) PCT No.: PCT/US2022/032214

§ 371 Date: Nov. 30, 2023

Related U.S. Application Data
(60) Provisional application No. 63/279,284, filed on Nov. 15, 2021.
(60) Provisional application No. 63/197,275, filed on Jun. 4, 2021.

(51) Int. Cl. C08L 27/16

(52) U.S. Cl. CPC C08L 27/16; C08L 2203/20; C08L 2205/02; C08L 2205/035

(57) ABSTRACT

Disclosed herein are electro-mechanical polymer compositions comprising a ferroelectric polymer chain having a plurality of functional halogen monomer units. At least one of the plurality of functional halogen monomer units can comprise a fluorinated alkyne monomer unit. The electro-mechanical polymer compositions can have an electromechanical coupling factor of about 88% or greater and a piezoelectric coefficient of −1000 pm/V or less. Also disclosed herein are methods of making the same.

### CROSS-REFERENCE TO RELATED APPLICATIONS

This application claims the benefit of U.S. Provisional Application Ser. No. 63/197,275, filed on 4 Jun. 2021 and U.S. Provisional Application Ser. No. 63/279,284, filed on 15 Nov. 2021, the entire contents and substance of which is incorporated herein by reference in its entirety as if fully set forth below.

### STATEMENT OF RIGHTS UNDER FEDERALLY SPONSORED RESEARCH

This invention was made with government support under Grant No. N00014-19-1-2028 awarded by the United States Navy Office of Naval Research. The government has certain rights in the invention.

### FIELD OF THE DISCLOSURE

The present disclosure relates generally to piezoelectric materials. Particularly, embodiments of the present disclosure related to electro-mechanical polymers exhibiting large strain coefficients and electromechanical coupling factors which can be used in electromechanical devices and systems.

### BACKGROUND

PVDF (polyvinylidene difluoride) and its copolymer of P(VDF-TrFE) (TrFE: trifluoroethylene) are the most widely used piezoelectric polymers in the market for transducers, sensors, actuators, soft robots, artificial muscles, and wearable devices such as haptics and/or haptic devices. However, many of these applications require large electromechanical actuation strain and high strain coefficient, ΔS/ΔE where ΔS is the electro-actuation strain generated under electric field ΔE, which are far beyond that of PVDF and P(VDF-TrFE) piezoelectric polymers. For example, the piezoelectric coefficient ΔS/ΔE of PVDF copolymers is below 35 pm/V, far lower than that of piezoceramics PZT which have ΔS/ΔE>700 pm/V. In addition, the electro-mechanical strain of the PVDF and P(VDF-TrFE) copolymers is far below 1%.

For example, in U.S. Pat. No. 6,787,238 entitled “Terpolymer systems for electromechanical and dielectric applications”, the contents of which are incorporated by reference herein, the inventors described that by modifying P(VDF-TrFE) copolymers into terpolymers, a large actuation strain (>7%) can be generated under 170 MV/m electric field. Although these high electroactive strain values (as well as high elastic modulus of the terpolymers >0.3 GPa) are attractive, for practical electromechanical devices, the electric breakdown (device failure) limits the electric field that can be used in the devices because operating at such a high field will result in device failure.

In addition, such high electric breakdown fields reported were frequently obtained on small size laboratory polymer samples. Commercial devices require much larger size polymer films, and the breakdown field of large size polymer films is much lower. For such device applications, the maximum fields allowed for devices are <60 MV/m, due to dielectric breakdown in polymer film devices. There is a need for new electromechanical polymers that generate a large actuation response under low electric fields compared with conventional relaxor terpolymers.

What is needed, therefore, are materials that can exhibit high electromechanical coupling properties while under a low electric field. Embodiments of the present disclosure address this need as well as other needs that will become apparent upon reading the description below in conjunction with the drawings.

### BRIEF SUMMARY OF THE DISCLOSURE

The present disclosure relates generally to piezoelectric materials. Particularly, embodiments of the present disclosure related to electro-actuator polymers exhibiting giant strain coefficients which can be used in piezoelectric materials and composites.

An exemplary embodiment of the present disclosure can provide an electro-mechanical polymer composition comprising a ferroelectric polymer chain substituted with a plurality of functional halogen monomer units, wherein at least one of the plurality of functional halogen monomer units comprises a fluorinated alkyne, alkyne, or vinylfluoride monomer unit and the electro-mechanical polymer composition has a thickness strain of at least about 3% under 50 MV/m of electric field measured at 1 Hz.

In any of the embodiments disclosed herein, the ferroelectric polymer chain can comprise vinylidene fluoride (VDF) and trifluoroethylene (TrFE).

In any of the embodiments disclosed herein, the electro-mechanical polymer material can comprise VDF in an amount from about 55 mol % to about 80 mol % and TrFE in an amount from about 20 mol % to about 30 mol %.

In any of the embodiments disclosed herein, the plurality of functional halogen monomer units can comprise one or more of chlorofluoroethylene (CFE), vinylchloride (VC), and chlorodifluoroethylene (CDFE).

In any of the embodiments disclosed herein, the electro-mechanical polymer composition can comprise CFE or VC or CDFE in an amount from about 3 mol % to about 7 mol %.

In any of the embodiments disclosed herein, the electro-mechanical polymer composition can comprise the fluorinated alkyne (FA), alkyne (HA), or vinylfluoride (VF) monomer unit in an amount from about 0.5 mol % to about 2.5 mol %.

In any of the embodiments disclosed herein, the electro-mechanical polymer composition can comprise the ferroelectric polymer chain in an all trans conformation.

In any of the embodiments disclosed herein, the electro-mechanical polymer composition can comprise the ferroelectric polymer chain in a TGTG′ conformation.

In any of the embodiments disclosed herein, the electro-mechanical polymer composition can comprise the ferroelectric polymer chain in a TGTGTG or TG′TG′TG′ conformation.

In any of the embodiments disclosed herein, the electro-mechanical polymer composition can comprise the ferroelectric polymer chain in a T₃GT₃G′ conformation.

In any of the embodiments disclosed herein, the electro-mechanical polymer composition can have an elastic modulus of about 0.15 GPa or greater.

In any of the embodiments disclosed herein, the electro-mechanical polymer composition can have an electro-actuation response that is about 100 Hz or greater.

In any of the embodiments disclosed herein, the electro-mechanical polymer composition can have a strain response at 100 Hz that is about 75% or greater of the actuation response at 1 Hz.

Examples of the present disclosure can also provide an electro-mechanical polymer composition comprising a ferroelectric polymer chain having a plurality of functional halogen monomer units, wherein at least one of the plurality of functional halogen monomer units comprises a fluorinated alkyne or vinylfluoride monomer unit and the electro-mechanical polymer composition has an electromechanical coupling factor of about 70% or greater and a piezoelectric coefficient of −700 pm/V or less.

In any of the embodiments disclosed herein, the ferroelectric polymer chain can comprise vinylidene fluoride (VDF) and trifluoroethylene (TrFE).

In any of the embodiments disclosed herein, the electro-mechanical polymer material can comprise VDF in an amount from about 55 mol % to about 80 mol % and TrFE in an amount from about 20 mol % to about 30 mol %.

In any of the embodiments disclosed herein, the plurality of functional halogen monomer units can comprise one or more of chlorofluoroethylene (CFE), vinylchloride (VC) and chlorodifluoroethylene (CDFE).

In any of the embodiments disclosed herein, the electro-mechanical polymer composition can comprise CFE in an amount from about 3 mol % to about 7 mol %.

In any of the embodiments disclosed herein, the electro-mechanical polymer composition can comprise the fluorinated alkyne, alkyne, or vinylfluoride monomer unit in an amount from about 0.5 mol % to about 2.5 mol %.

In any of the embodiments disclosed herein, the electro-mechanical polymer composition can comprise the ferroelectric polymer chain in an all trans conformation.

In any of the embodiments disclosed herein, the electro-mechanical polymer composition can comprise the ferroelectric polymer chain in a TGTG′ conformation.

In any of the embodiments disclosed herein, the electro-mechanical polymer composition can comprise the ferroelectric polymer chain in a TGTGTG or TG′TG′TG′ conformation.

In any of the embodiments disclosed herein, the electro-mechanical polymer composition can comprise the ferroelectric polymer chain in a T₃GT₃G′ conformation.

In any of the embodiments disclosed herein, the electro-mechanical polymer composition can have an elastic modulus of about 0.15 GPa or greater.

In any of the embodiments disclosed herein, the electro-mechanical polymer composition can have an electro-actuation response that is about 100 Hz or greater.

In any of the embodiments disclosed herein, the electro-mechanical polymer composition can have a strain response at 100 Hz that is about 75% or greater of the actuation response at 1 Hz.

In any of the embodiments disclosed herein, the electro-mechanical polymer composition can have a thickness strain of at least about 3% under 50 MV/m of electric field measured at 1 Hz.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1A depicts a sequential structure of an electro-mechanical polymer composition, in accordance with the present disclosure.

FIG. 1B depicts another sequential structure of an electro-mechanical polymer composition, in accordance with the present disclosure.

FIG. 2 illustrates schematic chemical structures of various chain conformations in electro-mechanical polymer compositions, in accordance with the present disclosure.

FIG. 3 illustrates a schematic of piezoelectric response of an electro-mechanical polymer composition under bias electrical field ED, in accordance with the present disclosure.

FIG. 4 illustrates a plot of thickness strain for electro-mechanical polymer compositions at 1 Hz unipolar field versus electric fields, in accordance with the present disclosure.

FIGS. 5A and 5B illustrate plots of strain and polarization, respectively, at 1 Hz AC field under 30 MV/m and 40 MV/m bias fields for electro-mechanical polymer compositions, in accordance with the present disclosure.

FIG. 6 illustrates a plot of thickness strain for an electro-mechanical polymer composition at 1 Hz unipolar field versus electric field, in accordance with the present disclosure.

FIGS. 7A and 7B illustrate plots of strain and polarization, respectively, at 1 Hz AC field under 40 MV/m bias field for an electro-mechanical polymer composition, in accordance with the present disclosure.

FIGS. 8A and 8B illustrate plots of polarization versus electric fields measured at 1 Hz for electro-mechanical polymer compositions, in accordance with the present disclosure.

FIGS. 9A and 9B illustrate plots of the effective dielectric constant and the electrostriction coefficient, respectively, versus applied electric fields for electro-mechanical polymer compositions, in accordance with the present disclosure.

FIGS. 10A and 10B illustrate plots of dielectric properties versus temperature measured at different frequencies for electro-mechanical polymer compositions, in accordance with the present disclosure.

FIG. 11A illustrates FT-IR spectra of electro-mechanical polymer compositions, in accordance with the present disclosure.

FIG. 11B illustrates corresponding fractions of different polymer bonds in the electro-mechanical polymer compositions shown in FIG. 11A, in accordance with the present disclosure.

FIG. 12 illustrates a plot of X-ray diffraction patterns for electro-mechanical polymer compositions, in accordance with the present disclosure.

FIG. 13 illustrates another plot of X-ray diffraction patterns for electro-mechanical polymer compositions, in accordance with the present disclosure.

FIGS. 14A-C illustrate X-ray diffraction patterns under different electric fields for electro-mechanical polymer compositions, in accordance with the present disclosure.

FIG. 15 illustrates a reaction scheme for making an electro-mechanical polymer composition, in accordance with the present disclosure.

### DETAILED DESCRIPTION

Disclosed herein are electro-mechanical polymer compositions comprising a ferroelectric polymer chain having a plurality of functional halogen monomer units. At least one of the plurality of functional halogen monomer units can comprise a fluorinated alkyne, alkyne, or vinylfluoride monomer unit. The electro-mechanical polymer compositions can have an electromechanical coupling factor of about 70% or greater and a piezoelectric coefficient of −700 pm/V or less. Also disclosed herein are methods of making the same.

Polarization changes in ferroelectric P(VDF-TrFE) polymers can originate from different processes: some show strong EM coupling, such as molecular conformation changes between TG (3/1 helix, TGTG′, and T₃GT₃G′) and all-trans bonds, while others do not contribute significantly to EM coupling (e.g., polarization reorientations between different crystal directions). Introducing a small amount of FA, HA or VF monomers in relaxor ferroelectric P(VDF-TrFE-CFE) polymers can markedly enhance the polarization changes between TG and all-trans bonds at low electric fields while suppressing the polarization reorientations. P(VDF-TrFE-CFE-FA) tetrapolymer with 1.9 mol % FA can generate a higher polarization change at fields below 60 MV/m, which leads to large electro-actuation. At higher fields, FA suppresses the polarization rotations that contribute little to EM coupling. Thus, at fields below 60 MV/m, the s-tetrapolymer possesses the electrostriction coefficient |Q₃₃| larger than 35 m⁴/C², more than 3× of that in P(VDF-TrFE-CFE) relaxor polymer. Under a low DC bias field of 40 MV/m, the s-tetrapolymer exhibits k₃₃ of 88% and d₃₃ of −1050 pm/V, far exceeding those of the widely used piezoceramic PZT.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable,” as used herein, refers to compounds that are not substantially altered when subjected to conditions to allow for their production, detection, and, in certain embodiments, their recovery, purification, and use for one or more of the purposes disclosed herein.

The term “spiro compound” refers to a chemical compound that presents a twisted structure of two or more rings, in which at least 2 rings are linked together by one common atom, e.g., a carbon atom. When the common atom is located in the center of the compound, the compound is referred to as a “spirocentric compound.” The common atom that connects the two or more rings is referred to as the “spiro-atom.” When such common atom is a carbon atom, it is referred to as the “spiro-carbon.”

Unless otherwise stated, all tautomeric forms of the compounds of the invention are within the scope of the invention.

Additionally, unless otherwise stated, structures depicted herein are also meant to include compounds that differ only in the presence of one or more isotopically enriched atoms. For example, compounds having the present structures except for the replacement of hydrogen by deuterium or tritium, or the replacement of a carbon by a 11C- or 13C- or 14C-enriched carbon are within the scope of this invention.

As used herein, “DB” means double bond. Fluorinated Alkynes (FA) means a fluoromonomer with a double bond. Alkynes (HA) means a hydrocarbon monomer with a double bond.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

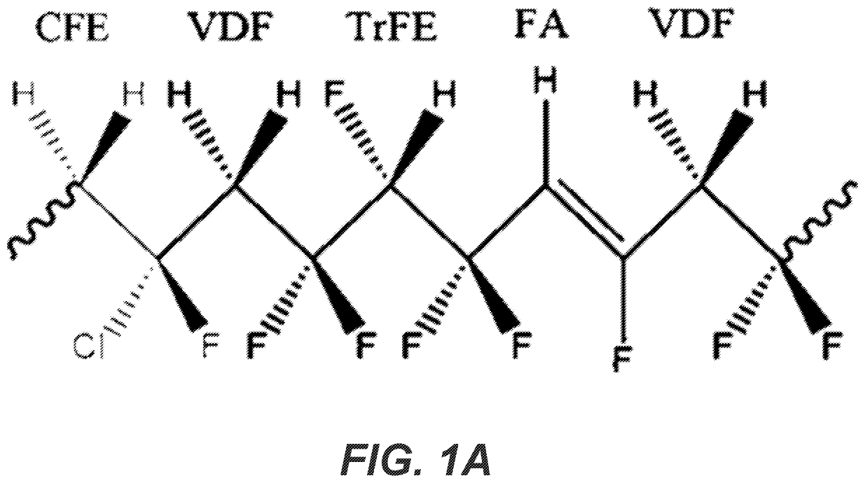

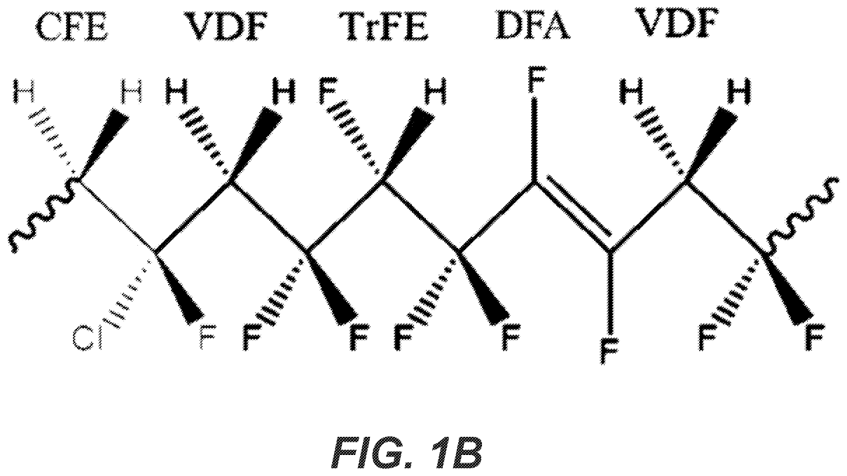

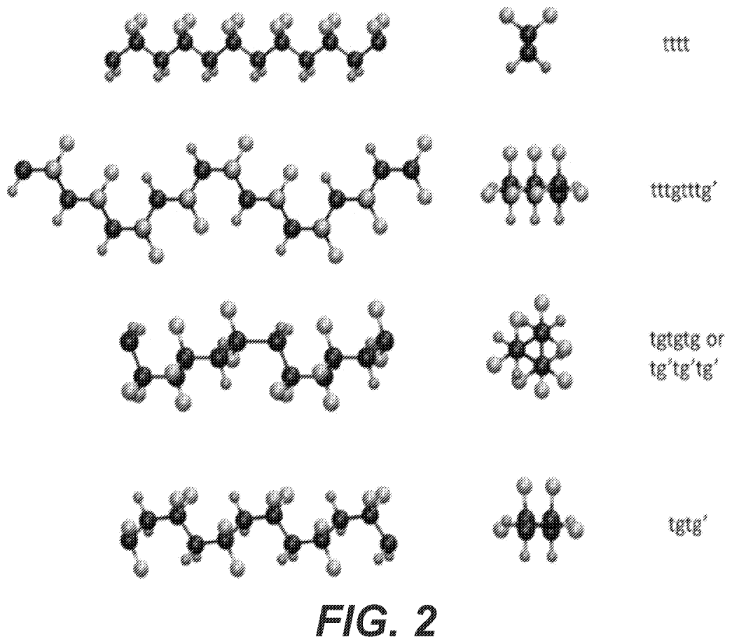

The disclosure includes at least one new class of modified P(VDF-TrFE) polymers for generating large actuation strain and large strain coefficient while maintaining the elastic modulus of at least about 0.15 GPa, similar to that of P(VDF-TrFE) based terpolymers. The disclosure further includes a class of electroactive polymers comprising VDF, TrFE, at least one monomer containing a halogen atom side group including CFE, VC, and CDFE, and FA, HA, or VFs. FIG. 1A and FIG. 1B are each example of chemical structures of this novel class of P(VDF-TrFE-CFE-FA) polymers. The structure of the FA is not limited. In certain embodiments, FA can have two structures, thus leading to the difference between FIG. 1A and FIG. 1B, and the various conformations shown in FIG. 2. As shown, the electro-mechanical polymer compositions of the present disclosure can have an all trans conformation, a TGTG′ conformation, a TTTGTTTG′ conformation, a TGTGTG or TG′TG′TG′ conformation, and/or a combination thereof.

Indeed, the structure of the FA can be altered as desired. The disclosed electro-mechanical polymer compositions can comprise any ferroelectric polymer chain substituted with a plurality of functional halogen monomer units. The ferroelectric polymer chain can be a relaxor ferroelectric polymer chain. The halogen monomer units can be selected as desired. The plurality of functional halogen monomer units can comprise a fluorinated alkyne (FA) as described above. The class of electroactive polymers can comprise VDF, TrFE, at least one monomer containing a halogen atom side group including CFE, VC, and CDFE, and Fluorinated Alkynes (FA), Alkynes (HA), or Vinylfluoride (VF).

The VDF can be present in the electro-mechanical polymer composition in an amount from about 50 mol % to about 80 mol % (e.g., from about 55 mol % to about 75 mol %, or from about 60 mol % to about 70 mol %), and the TrFE can be present in the electro-mechanical polymer composition in amount from about 15 mol % to about 35 mol % (e.g., from about 16 mol % to about 34 mol %, from about 17 mol % to about 33 mol %, from about 18 mol % to about 32 mol %, from about 19 mol % to about 31 mol %, from about 20 mol % to about 30 mol %, from about 21 mol % to about 29 mol %, from about 22 mol % to about 28 mol %, from about 23 mol % to about 27 mol %, or from about 24 mol % to about 26 mol %).

The CFE, the VC, or the CDFE can be present in the electro-mechanical polymer composition in an amount from about 0.1 mol % to about 10 mol % (e.g., from about 0.5 mol % to about 9 mol %, from about 1 mol % to about 8 mol %, from about 2 mol % to about 7 mol %, or from about 3 mol % to about 6 mol %), and the fluorinated alkyne can be present in the electro-mechanical polymer composition in an amount from about 0.1 mol % to about 5 mol % (e.g., from about 0.5 mol % to about 4 mol %, from about 1 mol % to about 3 mol %, or from about 1.5 mol % to about 2.5 mol %).

The electro-mechanical polymer composition can have an electromechanical coupling factor of about 70% or greater (e.g., from about 70% to about 100%, from about 80% to about 100%, from about 81% to about 100%, from about 82% to about 100%, from about 83% to about 100%, from about 84% to about 100%, from about 85% to about 100%, from about 86% to about 100%, from about 87% to about 100%, from about 88% to about 100%, from about 89% to about 100%, from about 90% to about 100%, or of about 88% or greater).

The electro-mechanical polymer composition can also have a piezoelectric coefficient of about −700 pm/V or less (e.g., about −800 pm/V or less, about −900 pm/V or less, about −1000 pm/V or less, about −1000 pm/V to about −5000 pm/V, about −1000 pm/V to about −4000 pm/V, about −1000 pm/V to about −3000 pm/V, about −1000 pm/V to about −2000 pm/V, or about −1000 pm/V to about −1100 pm/V).

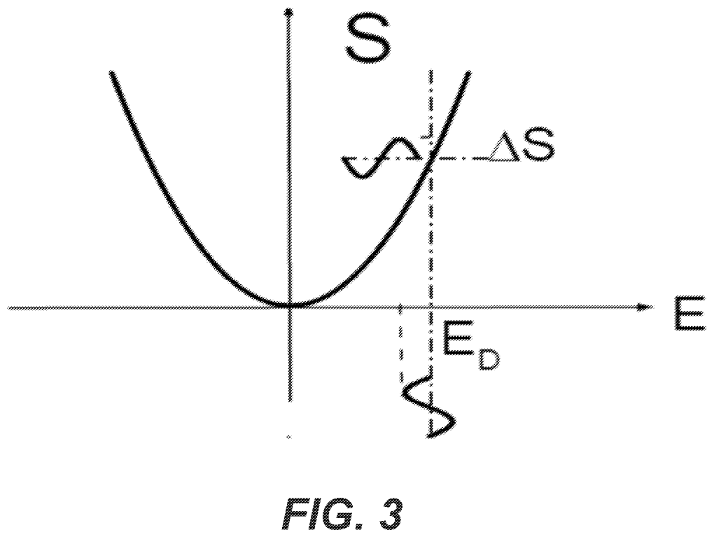

In ferroelectric materials, both the piezoelectric effect from the normal ferroelectrics and the electrostrictive effect from the relaxor ferroelectrics can be utilized for EM applications. As shown schematically in FIG. 3, biasing DC electric fields can generate piezoelectric states where EM response can be tuned by varying the DC bias field. Relaxor ferroelectric polymers can exhibit relatively high EM responses at high fields such as k₃₃ >50% at 120 MV/m. However, such high fields prohibit their applications in practical devices due to easy electric breakdown and failure. For the reliable operation of PVDF polymer-based dielectric devices, the applied fields can be as low as 60 MV/m or lower. Disclosed herein are relaxor ferroelectric P(VDF-TrFE-CFE-FA) (CFE: chlorofluoroethylene, FA: fluorinated alkynes) tetrapolymers that can generate large electrostriction at low electric fields. Under a low DC bias field of 40 MV/m, the tetrapolymer can exhibit k₃₃ of 88% and d₃₃ of −1050 pm/V, exceeding the state-of-the-art piezoceramic PZT.

The electromechanical responses of ferroelectric materials can be considered as arising from the electrostriction, e.g., the strain S is proportional to the square of the polarization P,

$${S}_{3} = {Q}_{33} {P}^{2} \qquad ( 1 )$$

where Q₃₃ is the electrostriction coefficient for the thickness strain. For piezoelectric coefficient d₃₃ (=ΔS₃/ΔE), d₃₃=2 Q₃₃ P_{b} ΔP/ΔE (ΔP/ΔE=ε₃₃), and the associated electromechanical coupling factor k₃₃,

$${k}_{33} = {d}_{33} \sqrt{Y / {ε}_{33}} = 2 {Q}_{33} {P}_{b} \sqrt{Y {ε}_{33}} \qquad ( 2 )$$

where P_{b} is the bias polarization, Y is the elastic modulus, and ε₃₃ is dielectric permittivity. In most ferroelectrics, the polarization P can be from many different processes. In inorganic ferroelectrics, P can originate from single ferroelectric domains and domain wall motions. In polymers such as PVDF-based ferroelectric semicrystalline polymers, in addition to the P from the crystalline phase, there can be additional polarization contributions from the amorphous phase and crystalline-amorphous interfaces. These different polarization processes can contribute to the EM response differently; that is, they will have different Q values in Eq. (1). For example, in P(VDF-TrFE) ferroelectric polymers, the polarization switch can be primary through successive 60° domain wall motions. Due to the pseudo-hexagonal symmetry of the unit cell, these domain wall motions will not generate high strain. From the literature, |Q₃₃| of P(VDF-TrFE) ferroelectric copolymers can usually be <3 m⁴/C², resulting in low k₃₃ and d₃₃. Hence, in developing PVDF-based ferroelectric polymers for generating large EM responses as disclosed herein, it is desirable to raise Q₃₃ and ε₃₃ while maintaining large polarization or also even enhancing P in PVDF-based polymers.

Based on these considerations, some examples of the disclosed electro-mechanical polymer compositions can comprise a P(VDF-TrFE-CFE) relaxor terpolymer. The relaxor ferroelectric terpolymer can exhibit a high dielectric constant K over a broad temperature range (K>50) near room temperature, much higher than P(VDF-TrFE) copolymers and other PVDF-based polymers.

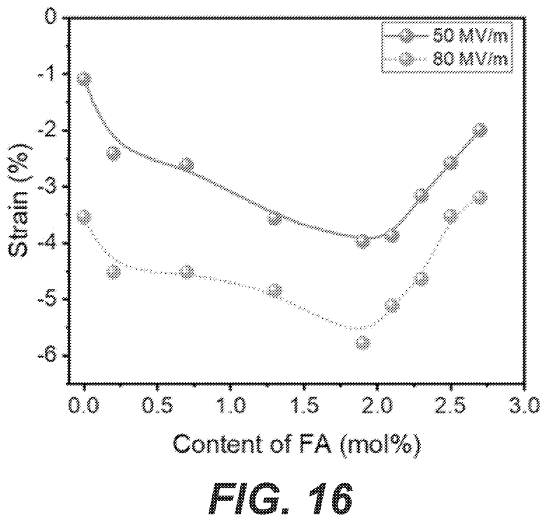

Some examples of the disclosed electro-mechanical polymer compositions can comprise FA monomer units, which have a smaller size than VDF and TrFE as random defects to modify P(VDF-TrFE-CFE) 63/29.7/7.3 mol % terpolymer, with the VDF/TrFE ratio of 68/32 mol %. A minimum of 7 mol % CFE can be used to completely convert ferroelectric P(VDF-TrFE) into relaxor ferroelectric. Without wishing to be bound by any particular scientific theory, smaller-size defects can be at least partially included in the crystalline phase and thus can be effective in controlling the polarization responses in the relaxor polymer. As illustrated in FIG. 15, such FA monomer units can be introduced easily in P(VDF-TrFE-CFE) by de-hydrochlorination of CFEs in the terpolymer. P(VDF-TrFE-CFE-FA) tetrapolymers with different FA contents can be synthesized and characterized. As shown in FIG. 16, the tetrapolymer with the 63/29.7/5.4/1.9 composition can display the highest electro-actuation. In electro-mechanical polymers such as PVDF-based ferroelectric polymers, the mechanical stretching of polymer films can align the polymer chains and generate morphology changes that can profoundly affect the electroactive responses of polymers.

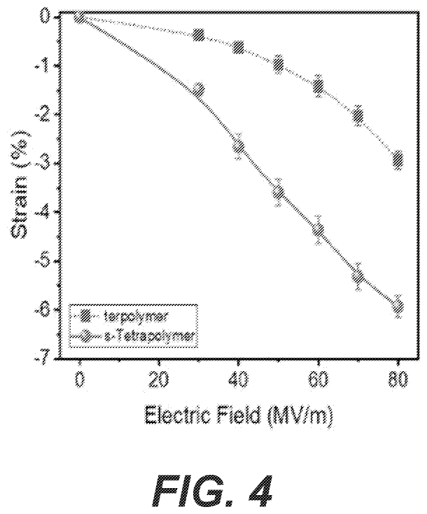

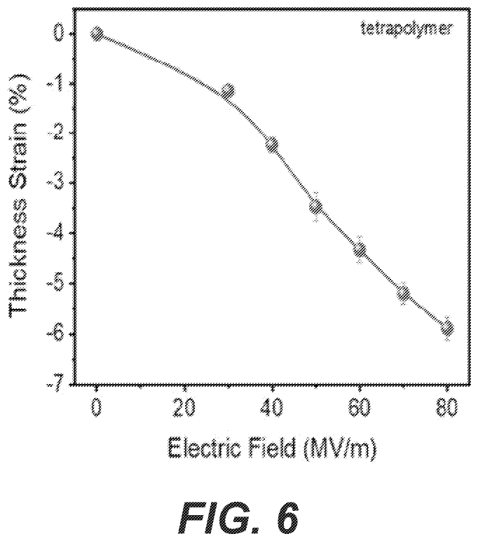

For PVDF-based ferroelectric polymers, electromechanical responses perpendicular and parallel to polymer chains have opposite signs, and thus in polymer films with randomly oriented chains, the combination of these competing effects can lower the electromechanical responses. Some examples of the disclosed electro-mechanical polymer compositions can be uniaxially stretched, with the tetrapolymer film with 1.9 mol % FA stretched to more than 7× stretching ratio. FIG. 4 and FIG. 6 present the thickness strain S₃ vs. the applied field (unipolar field) for the stretched tetrapolymer P(VDF-TrFE-CFE-FA) 63/29.7/5.5/1.9 mol %, referred to as s-tetrapolymer herein, at fields below 80 MV/m, in comparison with the terpolymer. S₃ of the s-tetrapolymer is −3.5% at 50 MV/m compared with −1% of the terpolymer, a marked enhancement. Although there can be large electroactuation at high electric fields (near dielectric breakdown), practical applications can require applied fields much lower than the breakdown fields for reliable device operation. In general, for dielectric devices such as polymer actuators and capacitors, the fields can be lower than 20% of the dielectric breakdown strength. For PVDF-based relaxors, this field can be below 60 MV/m.

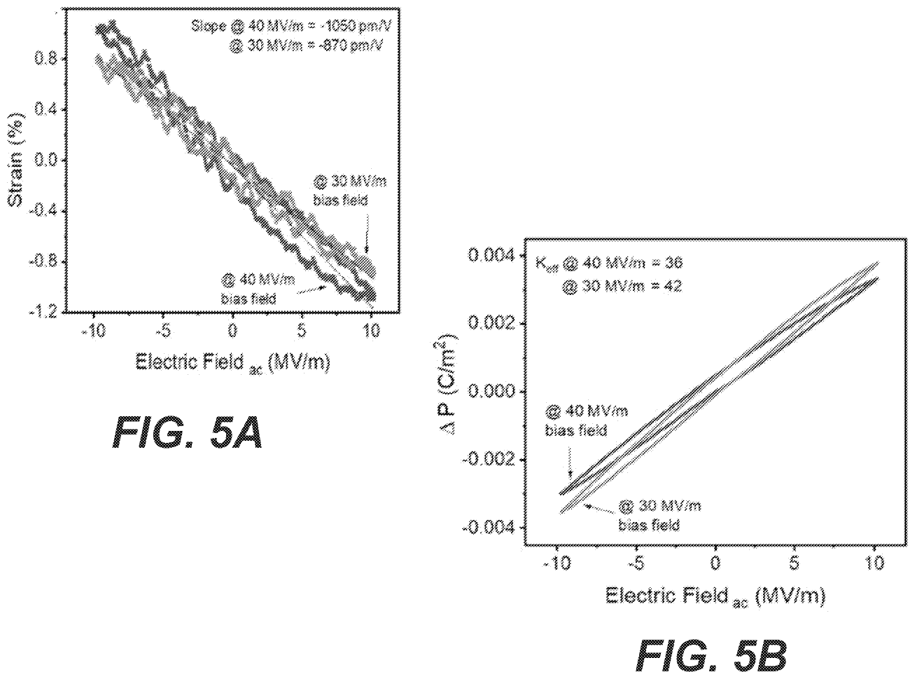

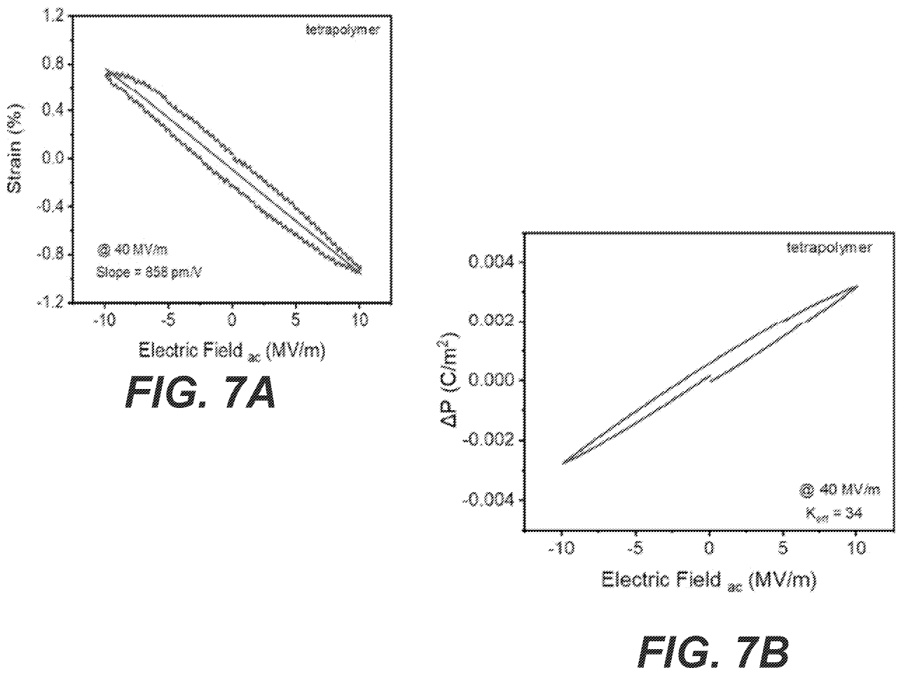

As shown in FIG. 3, DC bias field can be often used in electrostrictive materials to induce the piezoelectric state and a piezoelectric response. Some examples of the disclosed electro-mechanical polymer compositions can be characterized by electroactuation under ultralow DC bias fields, 30 and 40 MV/m, with the AC field amplitude of 10 MV/m. The strains and polarizations under the two DC biases are presented in FIGS. 5A and 5B for the s-tetrapolymer film and FIGS. 7A and 7B tetrapolymer. As presented in Table 1 below, the s-tetrapolymer film at 40 MV/m DC bias can generate d₃₃=−1050 pm/V, a value higher than that of the state-of-the-art piezoelectric PZT ceramics. The elastic modulus Y of unstretched tetrapolymer films can be measured as 0.224 GPa using dynamic mechanical analysis (DMA). The coupling factor k₃₃ can be deduced from d₃₃ \sqrt{Y/ε₃₃}, where ε₃₃ is from FIG. 5B. The d₃₃, K₃₃=ε₃₃/ε₀, where ε₀=8.85×10⁻¹² F/m is the vacuum permittivity, and k₃₃ in the DC-bias states for both s-tetrapolymer and tetrapolymer (unstretched), are summarized in Table 1, where the Y of the unstretched tetrapolymer films is used. The results reveal high piezoelectric performance of P(VDF-TrFE-CFE-FA) tetrapolymers, whose piezocoefficient d₃₃ of −1050 pm/V and coupling factor k₃₃ of 88% even at ultralow electric fields (<50 MV/m) far exceed that of the best piezoceramic PZT as well as lead-free piezoceramics, as presented in Table 1. Table 2 summarizes the EM performance of another tetrapolymer composition.

TABLE 1
Summary of EM performance for the tetrapolymer at bias fields.
Electromechanical and dielectric properties of P(VDF-TrFE-CFE-FA)
63/29.7/5.4/1.9 at DC biased states.

| DC bias | d₃₃ (pm/V) | K | k₃₃ |
|---|---|---|---|
| 30 MV/m (Tetrapolym) | −747 | 40 | 59% |
| 30 MV/m (s-Tetrapolym) | −890 | 42 | 69% |
| 40 MV/m (Tetrapolym) | −858 | 34 | 74% |
| 40 MV/m (s-Tetrapolym) | −1050 | 36 | 88% |

TABLE 2
Summary of EM performance for P(VDF-TrFE-CFE-FA)
63.6/30/4.4/2 mol % tetrapolymer (unstretched) at bias fields.
Electromechanical and dielectric properties.

| DC bias | d₃₃ (pm/V) | K | K₃₃ | Y (GPa) |
|---|---|---|---|---|
| 20 MV/m | −1177 | 64 | 71% | 0.21 |
| 30 MV/m | −1280 | 60 | 80% | 0.21 |
| 40 MV/m | −1100 | 47 | 78% | 0.21 |

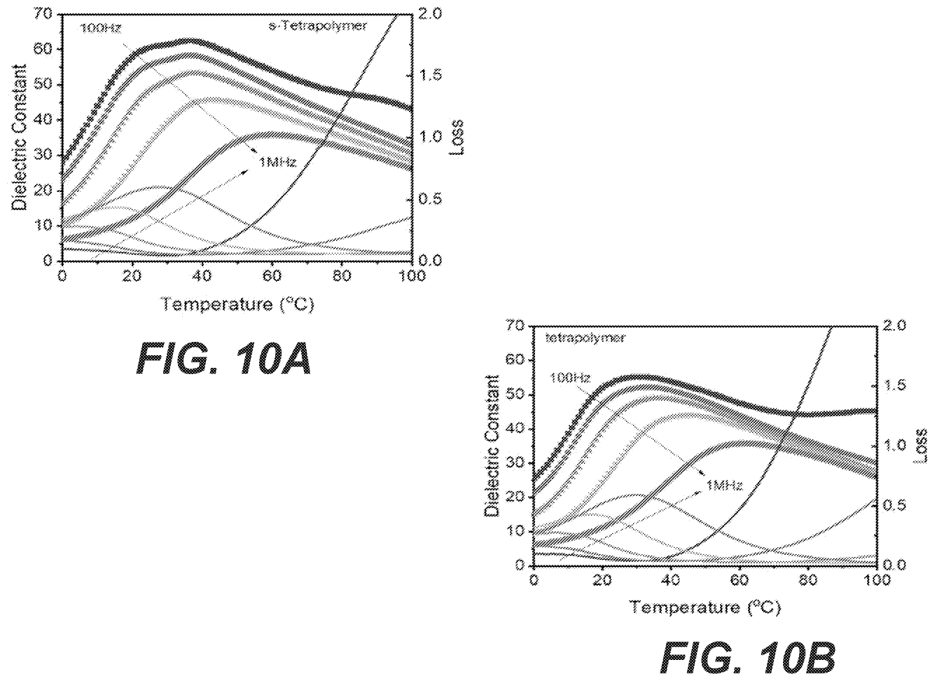

The dielectric properties versus frequency of s-tetrapolymer are presented in FIG. 10A. The dielectric data reveal that although there is not much change in the dielectric dispersion for s-tetrapolymer associated with the relaxor response, whose broad dielectric peak temperature shifts progressively towards lower temperature with frequency, there can be an additional (and broad) dielectric peak around 36° C. that does not move much with frequency, suggesting a diffused ferroelectric transition peak in the tetrapolymer, without wishing to be bound by any particular scientific theory.

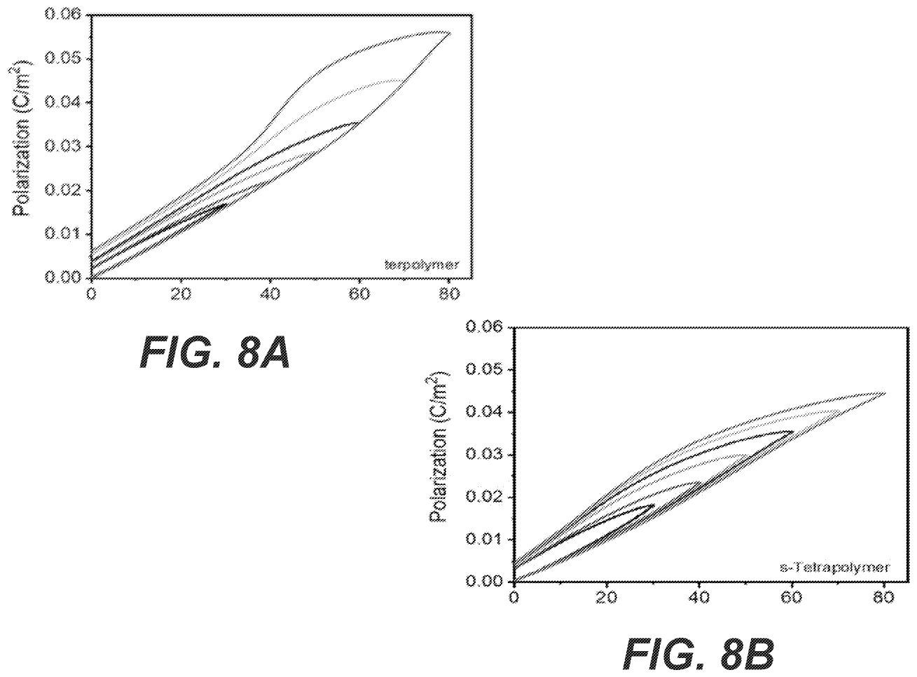

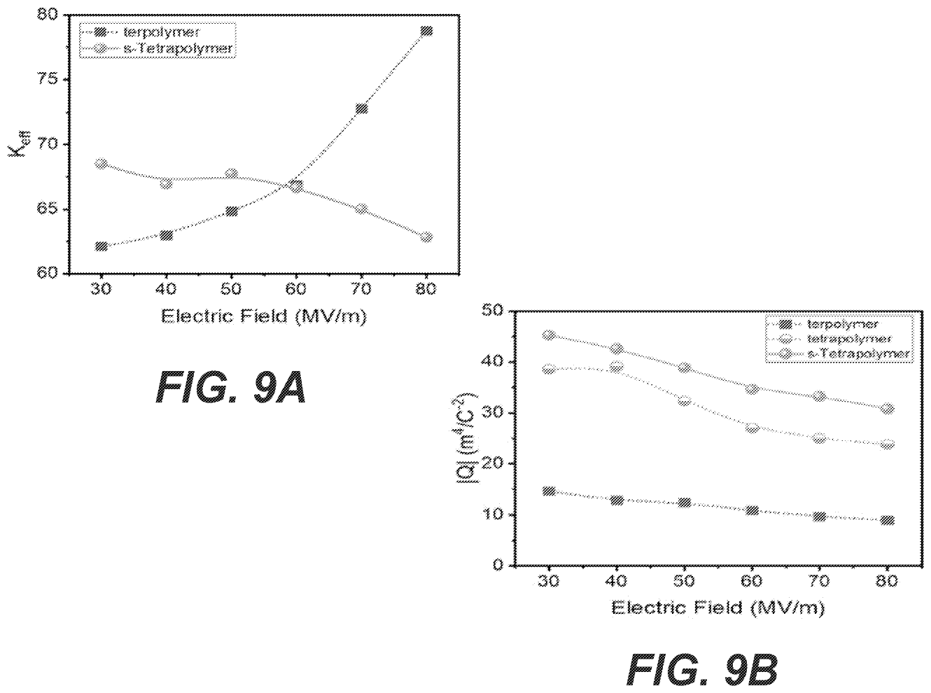

The polarization responses under unipolar electric fields are presented in FIGS. 8A and 8B for the terpolymer and s-tetrapolymer (and the dielectric properties of the tetrapolymer are shown in FIG. 10B). In relaxor ferroelectrics, there can be a critical field E, above which the relaxor transitions to a ferroelectric phase. The large increase in the polarization and polarization hysteresis in the P-E data of terpolymer can indicate a transition to ferroelectric at fields around 60 MV/m in terpolymers, while there is no such transition for the s-tetrapolymer at the experimental fields (up to 80 MV/m). To make a quantitative comparison, the disclosed electro-mechanical polymer compositions are plotted in FIG. 9A showing the P/E ratio vs. applied field [K_{eff}=P/(ε₀E)] for the terpolymer and the s-tetrapolymer. The terpolymer can have lower K_{eff} and hence lower polarization values than those of the s-tetrapolymer at fields below 60 MV/m. Above 60 MV/m, the field-induced transition to the ferroelectric phase can raise the polarization, polarization hysteresis, and K_{eff} above those of s-tetrapolymers. In other words, the FA “defects” in the s-tetrapolymer can lower the local polarization switch barriers, which can result in higher polarization response at fields below 60 MV/m. At fields higher than that, the FA “defects” can also prevent the transition of relaxor to the ferroelectric phase. All these characteristics can be desirable for generating high EM response and high EM coupling.

From the electro-actuation strains, the Q₃₃ for the s-tetrapolymer can be calculated from Eq. (1) at different electric fields, as presented in FIG. 9C. For comparison, the Q₃₃ for the terpolymer is also shown in FIG. 9C. Maxwell stress can generate more than 50% of the observed electro-actuation for the terpolymer, and hence the “true” Q₃₃ is only about ½ of that in FIG. 9B. Hence, the s-tetrapolymer data show more than 4× improvement in Q₃₃. The data also reveal a gradual decrease of Q₃₃ value with fields, without wishing to be bound by any particular scientific theory. At fields ≤40 MV/m, the s-tetrapolymer can exhibit a |Q₃₃|>42 m⁴/C². |Q₃₃| can become smaller with applied field (at 80 MV/m, |Q₃₃| of s-tetrapolymer is 32 m⁴/C²). Such a reduction unveils that the polarization at high fields becomes less effective in generating electro-actuation, likely caused by the residual transition from relaxor to ferroelectric phase and without wishing to be bound by any particular scientific theory.

Without wishing to be bound by any particular scientific theory, the above results can demonstrate that in PVDF-based ferroelectric polymers, the majority of the polarization changes do not contribute much to the EM performance, thus yielding a low EM coupling factor and small d₃₃. In the ferroelectric phase, polarization rotations can generate very little electromechanical response. The exceptionally large |Q₃₃| in the relaxor tetrapolymer can indicate that FA “defects” can effectively suppress the polarization responses that do not contribute much to the electromechanical response. Q₃₃ can be calculated from d₃₃=2 Q₃₃ P_{b} ΔP/ΔE for the s-tetrapolymer films at the two DC bias fields. Q₃₃ of s-tetrapolymer films in the DC-biased state can reach more than 60 m⁴/C² while the dielectric constant K (˜40) can be lower than that at zero bias field in FIGS. 8A and 10A.

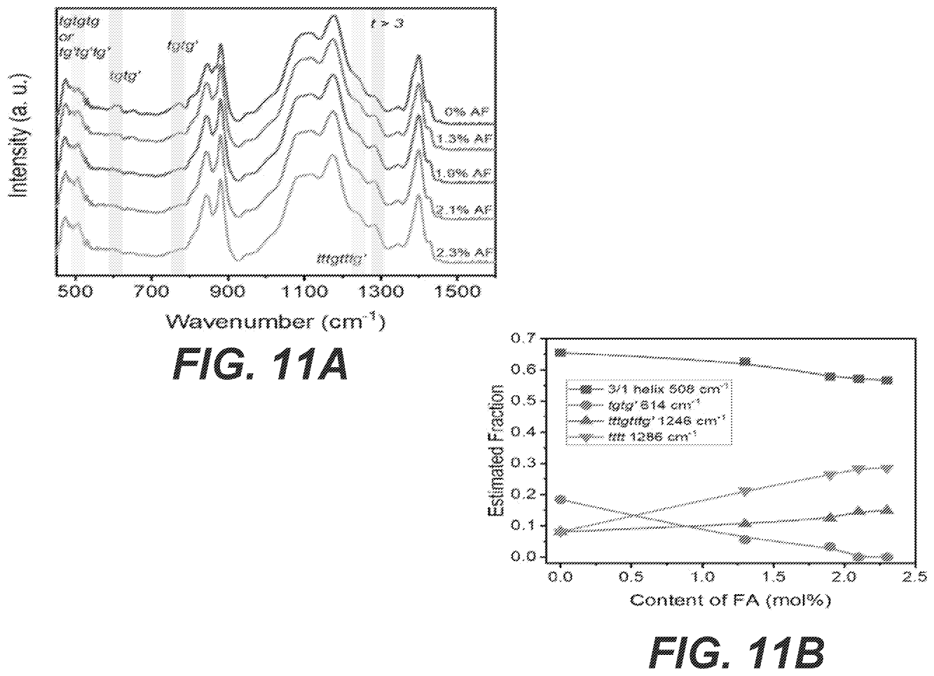

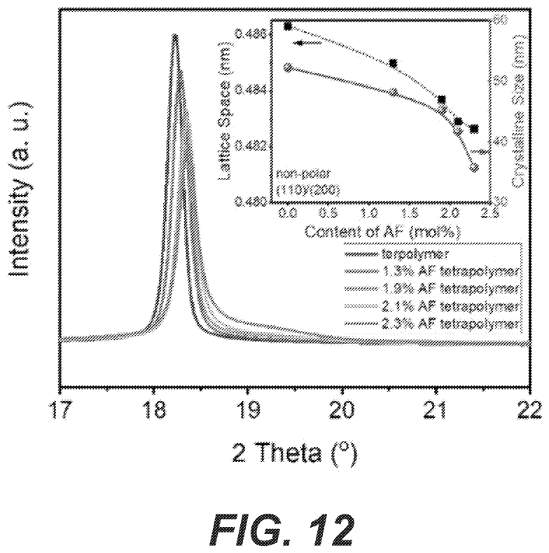

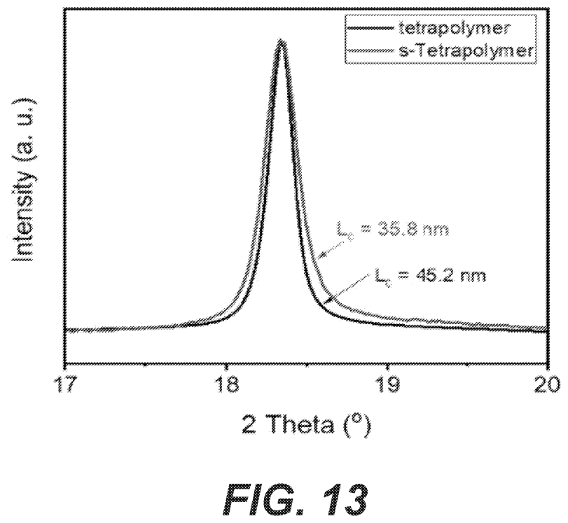

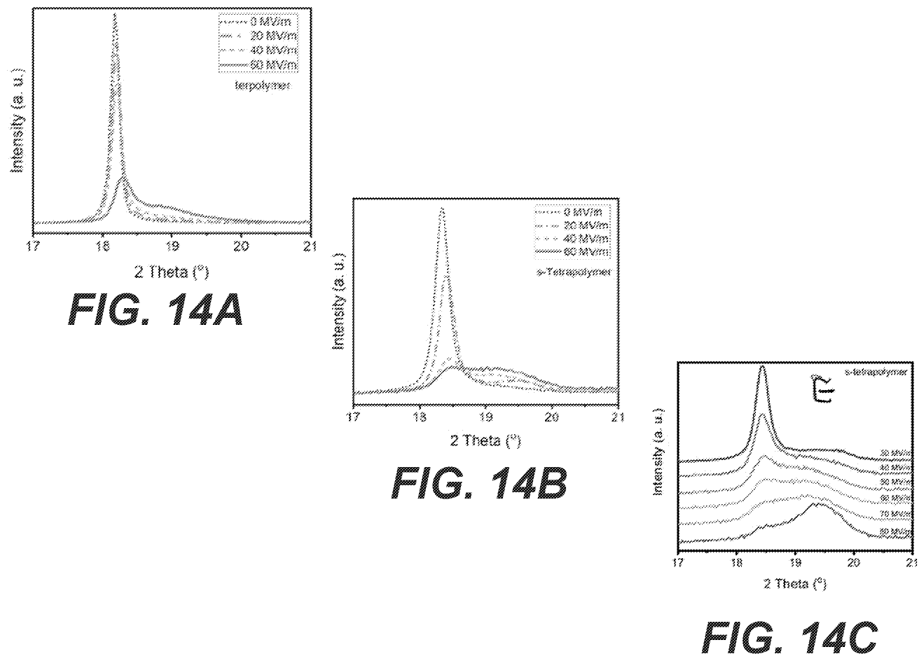

Some examples of the disclosed electro-mechanical polymer compositions can be analyzed by their molecular and mesoscopic structures related to the large EM coupling in the tetrapolymers. X-ray diffraction (XRD) reflection of (110/200) of tetrapolymers with different FA contents is presented in FIG. 12, showing that converting CFE to FA in the relaxor polymers can shift the (110/200) peak to higher angles (reducing the interchain spacing) and can cause a broadening of the reflection peak (reducing the coherent XRD crystalline region from ca. 51 nm to ca. 45 nm). The lattice spacing and coherent crystalline size are presented in the insert of FIG. 12. FIG. 13 presents a comparison of XRD (110/200) peak of s-tetrapolymer and unstretched tetrapolymer 1.9 mol % FA. Although there is no change in the peak position, there can be a large reduction of the coherent crystalline size from ca. 45 nm of unstretched tetrapolymer to ca. 36 nm of s-tetrapolymer. The results suggest that stretching can increase the inclusion of FAs in the crystalline phase, generating defect structures that reduce the coherent-scattering crystalline region of the XRD peak, without wishing to be bound by any particular scientific theory. Comparison of Fourier transform infrared (FT-IR) spectra of terpolymer and tetrapolymers, FIG. 11A, reveals that converting CFE into FA causes an increase in the all-trans bonds and a reduction of 3/1 helix bonds (responsible for the relaxor) and TGTG′ bonds (see FIG. 11B). These are consistent with the reduced interchain spacing of FIG. 12.

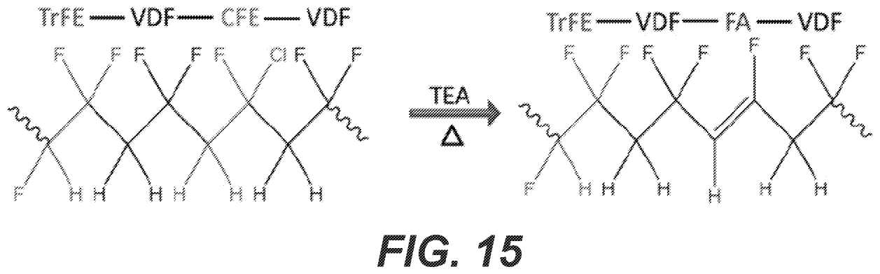

XRD around (110/200) peak of s-tetrapolymer and terpolymer under different applied fields are compared in FIGS. 14A and 14B (more XRD curves for the s-tetrapolymer in fields between 30 and 80 MV/m are presented in FIG. 14C). For the terpolymer, there is little change in the XRD peak at electric fields≤40 MV/m, consistent with the low actuation strain at these fields. In contrast, even at 20 MV/m, the tetrapolymer film already exhibits a broad peak at 19.5°, in addition to the original peak at ca. 18.4º, indicating an induced polarization transition that reduces the interchain spacing (consistent with the strain data). In addition, the original (110/200) peak broadens from ca. 36 nm at zero electric field to ca. 23 nm at 40 MV/m. At 60 MV/m, the (110/200) peak region becomes very broad. The results indicate that converting CFEs to FAs to 1.9 mol % can significantly reduce the barriers for switching from non-polar (or less polar) bonds to polar bonds locally in the crystalline phase, generating large EM actuations at low electric fields, consistent with the electroactuation results. At high fields of 80 MV/m, a broad peak at ca. 19.4° (FIG. 14C) of the s-tetrapolymer indicates the formation of a polar phase containing a high degree of “defects” that could be responsible for the reduced Q₃₃ at high fields in FIG. 9B.

In summary, polarization changes in ferroelectric P(VDF-TrFE) polymers can originate from different processes: some show strong EM coupling, such as molecular conformation changes between TG (3/1 helix, TGTG′, and T₃GT₃G′) and all-trans bonds, while others do not contribute significantly to EM coupling (e.g., polarization reorientations between different crystal directions). Introducing a small amount of FA monomers in relaxor ferroelectric P(VDF-TrFE-CFE) polymers can markedly enhance the polarization changes between TG and all-trans bonds at low electric fields while suppressing the polarization reorientations. P(VDF-TrFE-CFE-FA) tetrapolymer with 1.9 mol % FA can generate a higher polarization change at fields below 60 MV/m, which can lead to large electro-actuation. At higher fields, FA can suppress the polarization rotations that contribute little to EM coupling. Thus, at fields below 60 MV/m, the s-tetrapolymer can possess the electrostriction coefficient |Q₃₃| larger than 35 m⁴/C², more than 3× of that in P(VDF-TrFE-CFE) relaxor polymer. Under a low DC bias field of 40 MV/m, the s-tetrapolymer can exhibit k₃₃ of 88% and d₃₃ of −1050 pm/V, far exceeding those of the widely used piezoceramic PZT.

The electric breakdown in dielectrics such as EC films can be a statistic phenomenon, as described by the Weibull statistic model:

$$P ( E ) = 1 - exp ( - {( E / α )}^{β} ) , \qquad ( 3 )$$

where E is the electric field and P(E) is the probability of the sample to breakdown at electric field E. The fitting parameters α and β reflect the characteristic value (electric field under which 63.2% of the samples breakdown) and statistical spread of the breakdown field, respectively.

For a dielectric film with a given thickness, the Weibull breakdown field a can be scaled by the Weibull distribution with film area A:

$${α}_{1} = {{α}_{0} ( {A}_{0} / {A}_{x} )}^{1 / β} , \qquad ( 4 )$$

where α₀ and α₁ denote the Weibull breakdown measured from films of area A₀ and Aₓ, respectively, produced using the same fabrication process. The terpolymer films as disclosed herein can have aWeibull α₀=362 MV/m and β=7, measured on 10 μm thick films with electrodes of 2.3 mm diameter (A₀=0.042 cm²). By way of illustration, using the disclosed terpolymer films in an EC device that can operate in an ideal cooling cycle under 70 MV/m and at a frequency of 1 Hz, in order to generate 2° ° C. cooling at room temperature (T_{c}=293 K) (e.g., the temperature difference between the hot and cold ends Tₕ−T_{c}=2° C.) with a cooling power of 1 W, can require Aₓ=260 cm². This can lead to α₁=104 MV/m from Eq. (4). The probability of breakdown can be 6.1×10-2, implying that the device will fail after only a few cycles even at 70 MV/m. Without wishing to be bound by any particular scientific theory, this phenomenon can be the reason why there are few EC device, and the cooling generated in these EC devices is far below 1 W.

On the other hand, a large area, high-quality polymer film (β>15 or even 25) can be produced through the disclosed advanced manufacturing process. Table 3 summarizes the probability of breakdown for the same EC terpolymer cooler, which utilizes high quality EC polymer films with α₀=362 MV/m and β=15 to β=25.

TABLE 3
Probability of failure for EC polymer films.

| | α₀ = 362 MV/m, | α₀ = 362 MV/m, | α₀ = 362 MV/m, |
|---|---|---|---|
| Properties for films A [symbol] = 260 cm² | β = 7 A₀ = 4.2 mm² | β = 15 A₀ = 4.2 mm² | β = 25 A₀ = 4.2 mm² |
| [symbol] , Weibull breakdown filed | 104 MV/m | 202 MV/m | 255 MV/m |
| P(E) at 70 MV/m for the terpolymer | 0. [symbol] | 1.2 × 10⁻⁷ | 1 × 10⁻¹⁴ |
| Coating power, 1 W | | | |
| P(E) at [symbol] MV/m for the EC tetrapolymer, | 0.0078 | 1.4 × 10⁻ [symbol] | <1 × 10⁻ [symbol] |
| Cooling power, 1 W | | | |
| Ratio of P(E) of the tetrapolymer/terpolymer | 0.13 | 0.012 | <0.01 |

[symbol]

indicates data missing or illegible when filed

As can be seen, the probability of failure at 70 MV/m is reduced to 1.2×10⁻⁷ and 1×10⁻¹⁴, respectively. The reduction in Weibull breakdown field a with device cooling power is much smaller.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

### EXAMPLES

The following examples are provided by way of illustration but not by way of limitation.

P(VDF-TrFE-CFE) terpolymer is dissolved under a dry nitrogen atmosphere at 50° C. in dimethylformamine (DMF) until it is fully dissolved. Then, trimethylamine (TEA) (1.5 mL, 10.7 mmol) is added to a solution of terpolymer (500 mg) in 6 mL DMF under stirring and nitrogen atmosphere at 50° C. and then reacted for different times to thereby form different compositions, each having a different DB amount. A schematic of the process to convert a P(VDF-TrFE-CFE) terpolymer to a P(VDF-TrFE-CFE-FA) polymer in accordance with this Example is below:

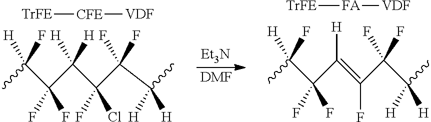

The chlorine and hydrogen atoms are removed by triethylamine, leaving a carbon-carbon double bond in the polymer chain as shown above. After reaction and upon cooling, the reaction mixture is poured into water or a mixed solvent of water and ethanol (volume ratio of 1:1) to remove the residual triethylamine and its salt and to precipitate the DB terpolymer. Deionized (DI) water was used to wash the polymers several times and then using ethanol was used to wash the polymers to remove the remaining TEA. The washed samples were placed in a vacuum oven at 35ºC for at least 24 hours to remove the water and ethanol, after which the dried polymers are ready to use.

### Comparative Example 1—PVDF-TrFE

A commercially available PVDF-TrFE piezopolymer was provided.

### Comparative Example 2—Relaxor Ferroelectric Terpolymer

A relaxor ferroelectric terpolymer P(VDF-TrFE-CTFE) was prepared according to U.S. Pat. No. 6,787,238 which had a ratio of P(VDF-TrFE-CTFE) of about 58.5 mol %/31.5 mol %/10 mol. %.

The performance results of Example 1 and Comparative Examples 1-2 are shown in TABLE 4 below. Notably, the Example 1 material exhibits a strain ΔS of at least 4.2% when exposed to a 50 MV/m electric field with an elastic modulus exceeding 0.15 GPa and an actuator frequency response of greater than 1 kHz, which is a significant improvement over the strain performance of Comparative Examples 1-2.

TABLE 4

| | Strain | | Elastic | | | | |
|---|---|---|---|---|---|---|---|
| | ΔS (%, at | ΔS/ΔE | modulus | Breakdown | | Dielectric | |
| Material | 50 MV/m | pm/V | (GPa) | Field | | Constant | Frequency |
| Ex. 1: P(VDF- | >4.2% | 840 | >0.15 | ~300 | MV/m | 55 | >1 kHz |
| TrFE-CFE-FA) | | | (GPa) | | | | |
| Comp. Ex. 1: | 0.17% | 33.5 | 3 GPa | 500 | MV/m | 8 | >1 kHz |
| PVDF-TrFE | | | | | | | |
| piezopolymer | | | | | | | |
| Comp. Ex. 2 | 1.15% | 230 | >0.15 | ~300 | MV/m | 55 | >1 kHz |
| Relaxor | | | (GPa) | | | | |
| ferroelectric | | | | | | | |
| terpolymer | | | | | | | |

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An electro-mechanical polymer composition comprising a ferroelectric polymer chain substituted with a plurality of functional halogen monomer units, wherein at least one of the plurality of functional halogen monomer units comprises a fluorinated alkyne or vinylfluoride monomer unit and the electro-mechanical polymer composition has a thickness strain of at least about 3% under 50 MV/m of electric field measured at 1 Hz.

2. The electro-mechanical polymer composition of claim 1, wherein the ferroelectric polymer chain comprises a relaxor ferroelectric polymer chain.

3. The electro-mechanical polymer composition of claim 1, wherein the ferroelectric polymer chain comprises vinylidene fluoride (VDF) and trifluoroethylene (TrFE).

4. The electro-mechanical polymer composition of claim 3, wherein the electro-mechanical polymer material comprises VDF in an amount from about 55 mol % to about 80 mol % and TrFE in an amount from about 20 mol % to about 30 mol %.

5. The electro-mechanical polymer composition of claim 1, wherein the plurality of functional halogen monomer units comprises one or more of chlorofluoroethylene (CFE), vinylchloride (VC), and chlorodifluoroethylene (CDFE).

6. The electro-mechanical polymer composition of claim 5, wherein the electro-mechanical polymer composition comprises CFE in an amount from about 3 mol % to about 7 mol %.

7. The electro-mechanical polymer composition of claim 1, wherein the electro-mechanical polymer composition comprises the fluorinated alkyne, alkyne, or vinylfluoride monomer unit in an amount from about 0.5 mol % to about 2.5 mol %.

8. The electro-mechanical polymer composition of claim 1, wherein:
a) the electro-mechanical polymer composition comprises the ferroelectric polymer chain in an all trans conformation;
b) the electro-mechanical polymer composition comprises the ferroelectric polymer chain in a TGTG′ conformation; and/or
c) the electro-mechanical polymer composition comprises the ferroelectric polymer chain in a TGTGTG or TG′TG′TG′ conformation.

9-10. (canceled)

11. The electro-mechanical polymer composition of claim 1, wherein the electro-mechanical polymer composition has an elastic modulus of about 0.15 GPa or greater.

12. The electro-mechanical polymer composition of claim 1, wherein the electro-mechanical polymer composition has an electro-actuation response that is about 100 Hz or greater.

13. The electro-mechanical polymer composition of claim 1, wherein the electro-mechanical polymer composition has a strain response at 100 Hz that is about 75% or greater of the actuation response at 1 Hz.

14. An electro-mechanical polymer composition comprising a ferroelectric polymer chain having a plurality of functional halogen monomer units, wherein at least one of the plurality of functional halogen monomer units comprises a fluorinated alkyne or alkyne monomer unit and the electro-mechanical polymer composition has an electromechanical coupling factor of about 70% or greater and a piezoelectric coefficient of −700 pm/V or less.

15. The electro-mechanical polymer composition of claim 14, wherein the ferroelectric polymer chain comprises a relaxor ferroelectric polymer chain.

16. The electro-mechanical polymer composition of claim 14, wherein the ferroelectric polymer chain comprises vinylidene fluoride (VDF) and trifluoroethylene (TrFE).

17. The electro-mechanical polymer composition of claim 16, wherein the electro-mechanical polymer material comprises VDF in an amount from about 55 mol % to about 80 mol % and TrFE in an amount from about 20 mol % to about 30 mol %.

18. The electro-mechanical polymer composition of claim 14, wherein the plurality of functional halogen monomer units comprises one or more of chlorofluoroethylene (CFE), vinylchloride (VC), and chlorodifluoroethylene (CDFE).

19. The electro-mechanical polymer composition of claim 18, wherein the electro-mechanical polymer composition comprises CFE in an amount from about 3 mol % to about 7 mol %.

20. The electro-mechanical polymer composition of claim 14, wherein the electro-mechanical polymer composition comprises the fluorinated alkyne, alkyne, or vinylfluoride monomer unit in an amount from about 0.5 mol % to about 2.5 mol %.

21. The electro-mechanical polymer composition of claim 14, wherein:
a) the electro-mechanical polymer composition comprises the ferroelectric polymer chain in an all trans conformation;
b) the electro-mechanical polymer composition comprises the ferroelectric polymer chain in a TGTG′ conformation; and/or
c) the electro-mechanical polymer composition comprises the ferroelectric polymer chain in a TGTGTG or TG′TG′TG′ conformation.

22-23. (canceled)

24. The electro-mechanical polymer composition of claim 14, wherein:
a) the electro-mechanical polymer composition has an elastic modulus of about 0.15 GPa or greater;
b) the electro-mechanical polymer composition has an electro-actuation response that is about 100 Hz or greater;
c) the electro-mechanical polymer composition has a strain response at 100 Hz that is about 75% or greater of the actuation response at 1 Hz; and/or
d) the electro-mechanical polymer composition has a thickness strain of at least about 3% under 50 MV/m of electric field measured at 1 Hz.

25-27. (canceled)
